(19) United States
(12) Patent Application Publication
(10) Pub. No.: US 2021/0263668 A1
(43) Pub. Date: Aug. 26, 2021

(54) INFORMATION PROCESSING DEVICE AND COMPUTER-READABLE RECORDING MEDIUM RECORDING STORAGE CONTROL PROGRAM

(71) Applicant: FUJITSU LIMITED, Kawasaki-shi (JP)

(72) Inventor: Kazuhiro URATA, Kawasaki (JP)

(73) Assignee: FUJITSU LIMITED, Kawasaki-shi (JP)

(21) Appl. No.: 17/142,285

(22) Filed: Jan. 6, 2021

(30) Foreign Application Priority Data
Feb. 21, 2020 (JP) 2020-028716

(51) Int. Cl. G06F 3/06

(52) U.S. Cl. CPC G06F 3/0652; G06F 3/0673; G06F 3/0604

(57) ABSTRACT

An information processing device includes: a memory; and a processor coupled to the memory and configured to: receive an instruction to write data, executes processing to write the data to storage space of a storage device, and acquires first usage by in-use data in the storage space according to content of the write processing when the write processing has been executed; and determine setting of a space freeing-up process, based on the first usage acquired by the write processing unit and second usage by all data stored in the storage space, and executes the space freeing-up process with the determined setting.

### CROSS-REFERENCE TO RELATED APPLICATION

This application is based upon and claims the benefit of priority of the prior Japanese Patent Application No. 2020-28716, filed on Feb. 21, 2020, the entire contents of which are incorporated herein by reference.

### FIELD

The embodiments discussed herein are related to a storage control device and a storage control program.

### BACKGROUND

There are storage devices employing a write-once storage method that prohibits erasure and change of data once written. Furthermore, some write-once storage devices have a deduplication function and a compression function.

International Publication Pamphlet No. WO 2015/097739, Japanese Laid-open Patent Publication No. 07-129470, and Japanese Laid-open Patent Publication No. 09-330185 are disclosed as related art.

### SUMMARY

According to an aspect of the embodiments, an information processing device includes: a memory; and a processor coupled to the memory and configured to: receive an instruction to write data, executes processing to write the data to storage space of a storage device, and acquires first usage by in-use data in the storage space according to content of the write processing when the write processing has been executed; and determine setting of a space freeing-up process, based on the first usage acquired by the write processing unit and second usage by all data stored in the storage space, and executes the space freeing-up process with the determined setting.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a hardware configuration diagram of a storage system;

FIG. 2 is a block diagram of a controller module according to a first embodiment;

FIG. 3 is a diagram depicting an example of a logical volume-side management table;

FIG. 4 is a diagram depicting an example of a physical volume-side management table;

FIG. 5 is a diagram depicting transitions of the management tables when new data is written;

FIG. 6 is a diagram depicting transitions of the management tables when duplicate data is written;

FIG. 7 is a diagram depicting transitions of the management tables when data is overwritten;

FIG. 8 is a diagram depicting process assignment when a garbage collection process is not assigned;

FIG. 9 is a diagram depicting process assignment when the priority of the garbage collection process is normal;

FIG. 10 is a diagram depicting process assignment when the priority of the garbage collection process is high;

FIG. 11 is an overall flowchart of the garbage collection process;

FIG. 12 is a flowchart of a pool usage calculation process;

FIG. 13 is a flowchart of a priority setting process according to the first embodiment;

FIG. 14 is a block diagram of a controller module according to a second embodiment; and

FIG. 15 is a flowchart of a priority setting process according to the second embodiment.

### DESCRIPTION OF EMBODIMENTS

In write-once deduplication storages having a deduplication function and a compression function, new non-duplicate write data is added to a physical disk without overwriting. Furthermore, data on a physical disk that is no longer referenced due to write-once deletion or overwriting is deleted from the physical disk asynchronously with data input and output by an unnecessary data deletion function called garbage collection. Therefore, the usage of a physical disk has the course of temporarily increasing at the time of write and then decreasing due to the operation of garbage collection.

For storage devices, physical disk usage is an important performance index. The smaller the usage, the more the original function of storage devices that is data storage can be fully utilized. Therefore, it is preferable for storage devices to keep physical disk usage as small as possible. In order to reduce physical disk usage as much as possible, garbage collection will be operated in write-once storage devices.

As such a garbage collection technique, there has been a technique that operates garbage collection at the point in time when write space becomes insufficient. Furthermore, there has been a technique that operates garbage collection when there is not enough free space to store new compressed data on a physical disk. Moreover, there has been a technique that executes garbage collection when unused space on physical disks becomes a certain value or less, and no access has come from a host device for a certain period of time.

However, in storage devices, load when garbage collection is operated has a large influence on performance. Therefore, it is preferable to avoid frequent execution of garbage collection if possible.

On the other hand, if execution frequency of garbage collection is reduced, there arises a problem that physical disk usage becomes larger than data that can actually be used. Furthermore, if garbage collection is not executed, it is difficult to determine whether there is data to be deleted. If the frequency of garbage collection is reduced, an increase in unnecessary data will not be noticed, and wasted space will increase on physical disks. Moreover, actual disk usage excluding unnecessary data that is not referenced is also unknown unless garbage collection is executed, and it becomes difficult to quickly find the occurrence of situations such as shortage of physical disk space. If these situations occur, storage devices does not free up sufficient storage space, and it becomes difficult to improve device performance.

In this respect, by the technique of operating garbage collection at the point in time when write space becomes insufficient, it is difficult to detect an increase in unnecessary data before write space becomes insufficient, and the execution of garbage collection may be delayed. In that case, it may be difficult to improve the device performance of storage devices. This applies to the technique of operating garbage collection depending on the presence or absence of storage space for new compressed data, and the technique of executing garbage collection depending on unused space on physical disks and access frequency.

The disclosed technique has been made in view of the above, and a storage control device and a storage control program for improving the device performance of a storage device may be provided.

Hereinafter, embodiments of a storage control device and a storage control program disclosed in the present application will be described in detail with reference to the drawings. Note that the storage control device and the storage control program disclosed in the present application are not limited by the following embodiments.

### First Embodiment

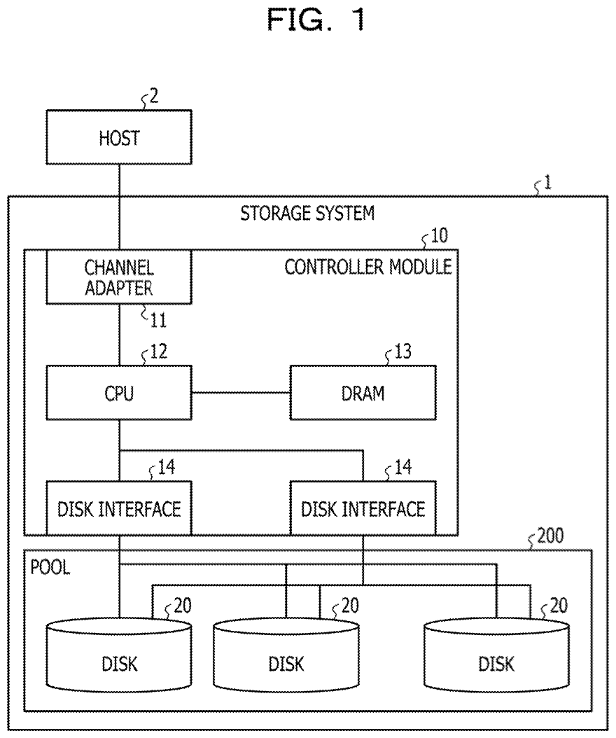

FIG. 1 is a hardware configuration diagram of a storage system. As depicted in FIG. 1, a storage system 1 is connected to a host 2 such as a server. Then, the storage system 1 includes a controller module 10 and a plurality of disks 20.

The host 2 transmits instructions to the storage system 1. The storage system 1 processes an instruction received from the host 2 and returns a response to the instruction to the host 2. Instructions from the host 2 include data write instructions and read instructions, etc. The data write instructions include a new data write instruction to write data not held by the storage system 1 and a duplicate data write instruction to write data that is a duplicate of existing data already held by the storage system 1. Further, the write instructions include an overwrite instruction to update existing data already held by the storage system 1.

The controller module 10 is a storage control device that generates a logical configuration of the disks 20 and reads and writes data from and to the disks 20. The controller module 10 includes a channel adapter 11, a central processing unit (CPU) 12, a dynamic random-access memory (DRAM) 13, and disk interfaces 14.

The channel adapter 11 is a communication interface to the host 2 connected to the host 2. The channel adapter 11 is connected to the CPU 12 and outputs an instruction received from the host 2 to the CPU 12. Further, the channel adapter 11 receives from the CPU 12 a response to the instruction received from the host 2. Then, the channel adapter 11 transmits the received response to the host 2.

The CPU 12 receives from the channel adapter 11 input of an instruction transmitted from the host 2. Then, the CPU 12 processes the received instruction. For example, the CPU 12 accesses the disks 20 via the disk interfaces 14 and executes data write or read processing. Then, the CPU 12 transmits processing results to the host 2 via the channel adapter 11 as a response to the instruction. Further, the CPU 12 combines the plurality of disks 20 to form a pool 200. The pool 200 corresponds to an example of “storage space”. Moreover, the CPU 12 constructs a logical configuration in which the disks 20 are combined in the pool 200. For example, the CPU 12 constructs redundant arrays of inexpensive disks (RAID) using the plurality of disks 20, forming a logical volume.

The CPU 12 actually writes and reads data to and from the disks 20 that are physical disks. For example, the CPU 12 is instructed to write or read to or from a volume that is a logical disk by an instruction from the host 2. Then, the CPU 12 converts information of access destination on the volume specified by the instruction from the host 2 into an address on a disk 20, and executes write processing or read processing on the disk 20. In other words, write processing or read processing is specified by the host 2 as processing on the logical volume, and actual data is stored on a disk 20 that is a physical volume by the controller module 10.

Furthermore, the CPU 12 develops and executes control programs of the storage system 1 in the DRAM 13. The control programs of the storage system 1 include, for example, a program for operating garbage collection etc., and the like.

The DRAM 13 is a main storage device. The DRAM 13 is also used as a cache in the storage system 1.

The disk interfaces 14 are communication interfaces to the disks 20. The disk interfaces 14 mediate data transmission and reception between the CPU 12 and the disks 20.

The disks 20 are physical disks such as hard disks, and constitute auxiliary storage devices. The disks 20 are combined to form one pool 200. Further, the disks 20 have a logical configuration constructed by the controller module 10. For example, one logical volume is constructed using the plurality of disks 20.

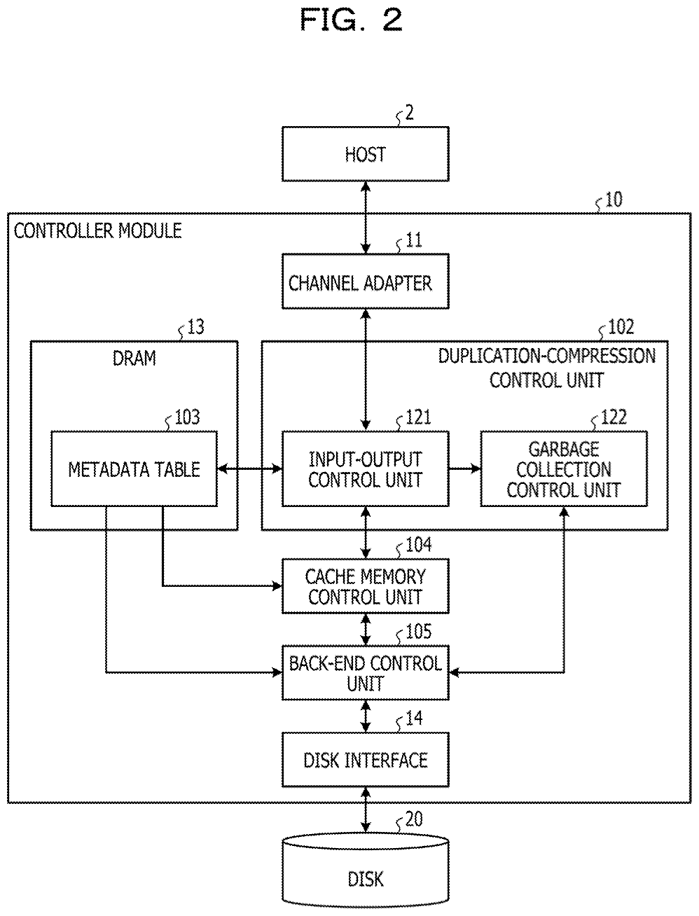

Next, the details of the controller module 10 will be described with reference to FIG. 2. FIG. 2 is a block diagram of the controller module according to the first embodiment.

The controller module 10 includes a duplication-compression control unit 102, a cache memory control unit 104, and a back-end control unit 105, which are implemented by the CPU 12. Further, a metadata table 103 is stored in the DRAM 13.

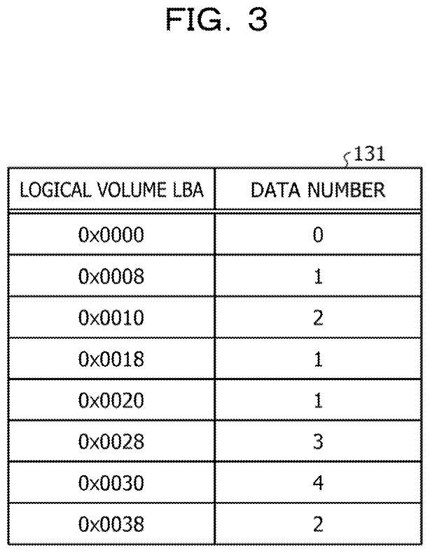

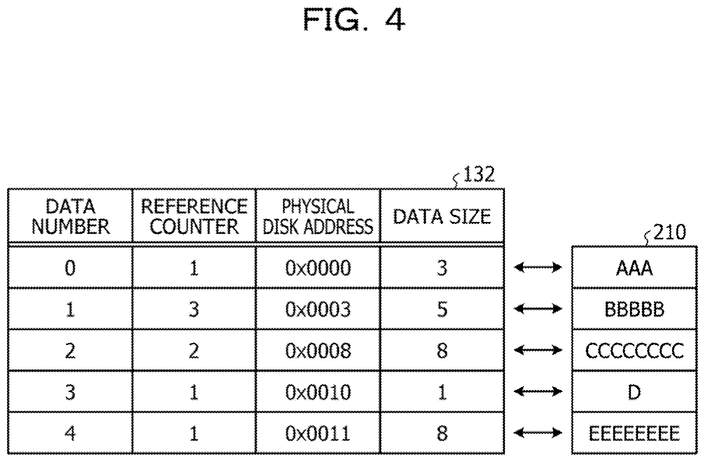

The metadata table 103 includes a management table 131 on the logical volume side depicted in FIG. 3 and a management table 132 on the physical volume side depicted in FIG. 4. FIG. 3 is a diagram depicting an example of the logical volume-side management table. Further, FIG. 4 is a diagram depicting an example of the physical volume-side management table.

The management table 131 shows data storage locations on a logical volume that is a logical disk. As depicted in FIG. 3, the management table 131 stores logical volume logical block addressing (LBA) and data numbers that are identification information of data stored on areas indicated by the logical volume LBA in association with each other. The data numbers registered in the management table 131 make it possible to identify which data on a physical volume that is a collection of the disks 20 is referenced through the management table 132 on the physical volume side.

The management table 132 shows data storage locations on the disks 20 that are physical disks. As depicted in FIG. 4, the management table 132 stores data numbers, reference counters, physical disk addresses, and data sizes in association with each other. For the data numbers, the data numbers stored in the management table 131 on the logical volume side are used. Each reference counter represents the number of references made to the data. Since the storage system 1 according to the present embodiment has the deduplication function, one piece of data may be referenced as different pieces of information. Each physical disk address represents an address on a disk 20 on which the data is stored. Then, data corresponding to each data number is stored on an area on a disk 20 specified by the physical disk address in the management table 132. Stored data 210 represents actual data stored on the disks 20 corresponding to the pieces of information registered in the management table 132.

The duplication-compression control unit 102 includes an input-output control unit 121 and a garbage collection control unit 122. The input-output control unit 121 holds in-use data usage that represents usage of the pool 200 by data referenced by being specified using the logical volume LBA, which is data in use. In other words, the pool usage is usage of data except unnecessary data that is data not referenced, of all data stored on the storage space of the pool 200. The pool usage corresponds to an example of “first usage”. Here, in the present embodiment, the usage of the storage space is calculated with reference to the pool 200, but any other storage space corresponding to storage space to store data may be used as a reference. For example, a logical volume may be used as a reference. The input-output control unit 121 initializes the pool usage to zero when the pool 200 is created.

The input-output control unit 121 receives input of an instruction transmitted from the host 2 via the channel adapter 11. Then, the input-output control unit 121 processes the acquired instruction. The operation of instruction processing of the input-output control unit 121 will be described below.

In the case of a read instruction, the input-output control unit 121 refers to the metadata table 103 and identifies the storage location of data to be read. Then, the input-output control unit 121 requests the cache memory control unit 104 to read the data at the identified storage location. After that, the input-output control unit 121 receives input of the data to be read from the cache memory control unit 104. Then, the input-output control unit 121 transmits the acquired data to the host 2 via the channel adapter 11.

In the case of a write instruction, the input-output control unit 121 determines whether the instruction is an overwrite instruction on existing data or a write instruction to add data. Further, in the case of a write instruction to add data, the input-output control unit 121 determines whether data to be written is new data that is not a duplication of existing data or duplicate data that is a duplication.

When it is a write instruction to add data and the data to be written is new data, the input-output control unit 121 determines the storage location of the new data to be written on a disk 20. Next, the input-output control unit 121 compresses and outputs the new data to be written to the cache memory control unit 104, and requests storage onto the determined storage location. Further, the input-output control unit 121 updates the metadata table 103. The details of the metadata table 103 in this case will be described below.

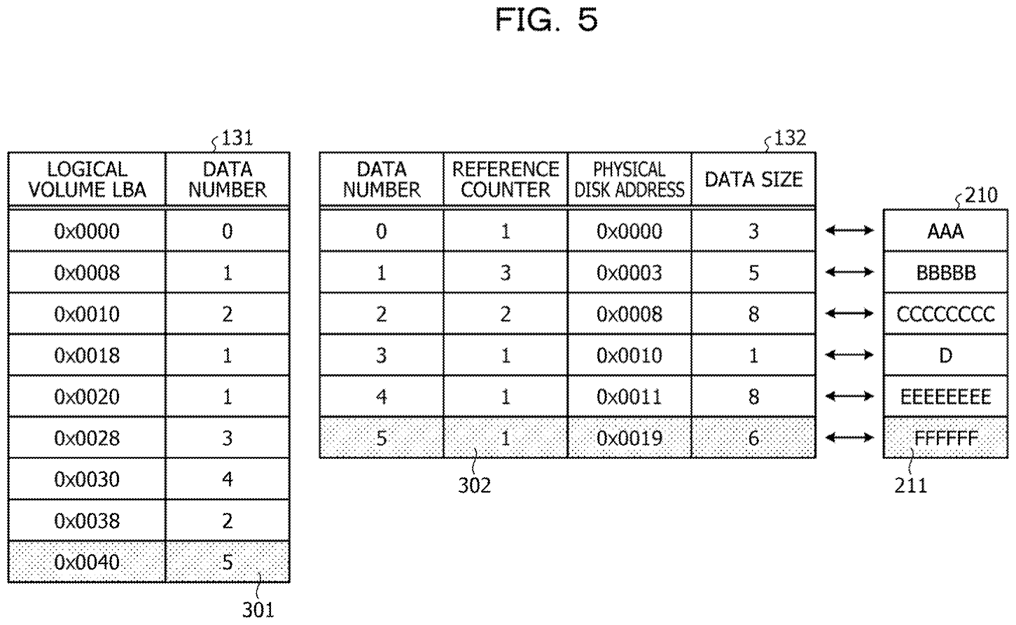

FIG. 5 is a diagram depicting transitions of the management tables when new data is written. Here, a case will be described in which the states of the management tables 131 and 132 before the new data is written are the states depicted in FIGS. 3 and 4.

The input-output control unit 121 registers the logical volume LBA of the new data together with the data number of the new data in a row 301 of the management table 131 on the logical volume side. Further, the input-output control unit 121 creates a new row 302 for the new data in the management table 132 on the physical volume side, registers the data number, and stores the physical disk address and the data size. Furthermore, since the stored new data is referenced by the newly added logical volume LBA, the input-output control unit 121 sets a reference counter in the new data row 302 in the management table 132 to one. In this case, data 211 corresponding to information of the new data in the row 302 is stored on the physical volume as the stored data 210.

In this case, since the new data that is referenced data is additionally stored in the pool 200, the input-output control unit 121 adds usage by the new data to the pool usage.

On the other hand, when it is a write instruction to add data and the data to be written is duplicate data, the input-output control unit 121 determines the storage location of the duplicate data to be written on a disk 20. Next, the input-output control unit 121 outputs the storage of information indicating duplicate existing data on the determined storage location to the cache memory control unit 104. After that, the input-output control unit 121 receives a write completion response from the cache memory control unit 104. Then, the input-output control unit 121 transmits the write completion response to the host 2 via the channel adapter 11. Further, the input-output control unit 121 updates the metadata table 103. The details of the metadata table 103 in this case will be described below.

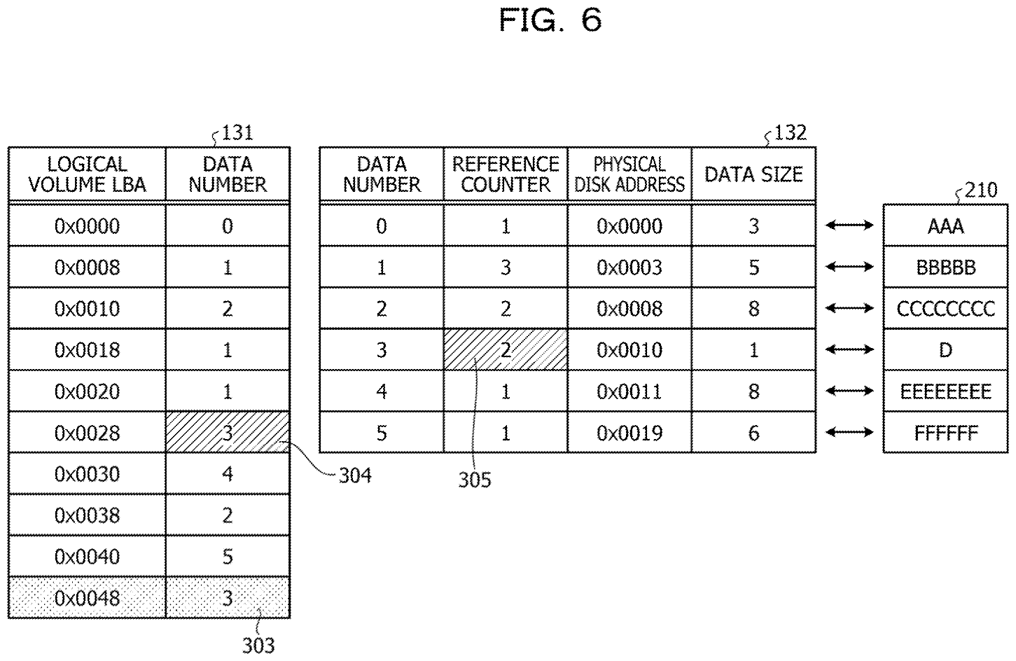

FIG. 6 is a diagram depicting transitions of the management tables when duplicate data is written. Here, a case will be described in which the states of the management tables 131 and 132 before the duplicate data is written are the states depicted in FIG. 5.

The input-output control unit 121 refers to the management table 131 on the logical volume side and identifies a row indicating original data that is the duplicate existing data. Then, the input-output control unit 121 acquires the data number of the original data from a column 304 indicating the data number of the identified row. Next, the input-output control unit 121 registers the data number of the original data as the data number of the duplicate data in a new row 303 of the management table 131 on the logical volume side, and registers the logical volume LBA of the duplicate data. Further, the input-output control unit 121 identifies a row indicating the original data in the management table 132 on the physical volume side. Then, the input-output control unit 121 increments a value in a reference counter column 305 in the identified row by one because a reference from the address stored this time to the original data is added. In this case, the duplicate data is not newly stored in the stored data 210.

In this case, since an increase in the usage of the pool 200 due to the duplicate data does not occur, the input-output control unit 121 keeps the value of the pool usage unchanged.

On the other hand, in the case of a write instruction to overwrite data, the input-output control unit 121 determines whether update data is new data or duplicate data, and stores the data and updates the management tables 131 and 132 by the method described above in each case. On the other hand, for original data to be overwritten, the input-output control unit 121 refers to the metadata table 103 and identifies information of the original data to be overwritten from the management table 132. Then, the input-output control unit 121 decrements the reference counter of the original data to be overwritten in the management table 132 by one. The details of the metadata table 103 in this case will be described below.

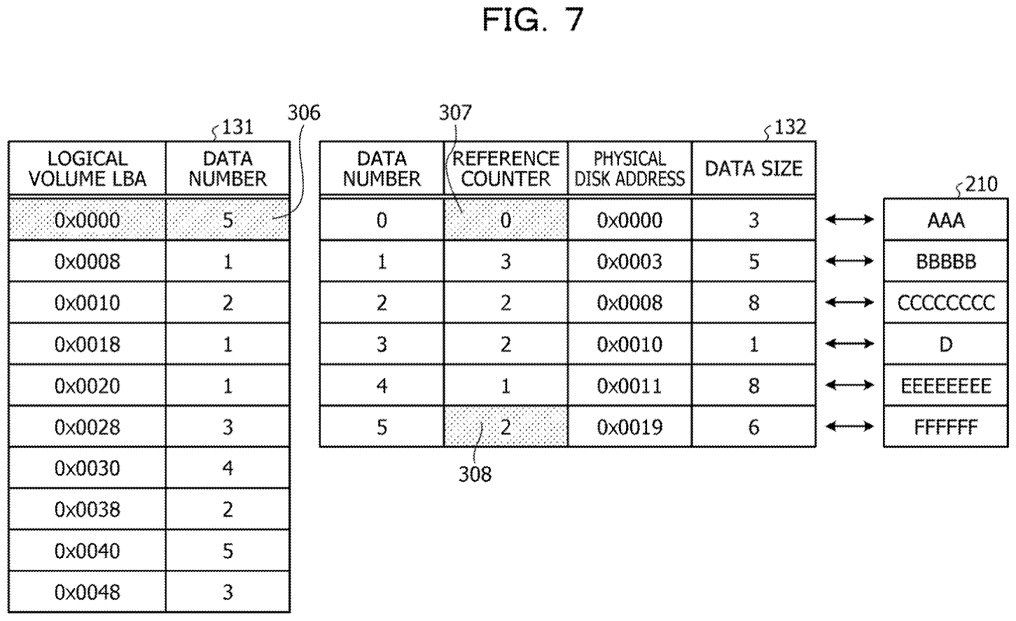

FIG. 7 is a diagram depicting transitions of the management tables when data is overwritten. Here, a case will be described in which the states of the management tables 131 and 132 before the data is overwritten are the states depicted in FIG. 6. FIG. 7 depicts overwriting when the update data is duplicate data.

The input-output control unit 121 refers to the management table 131 on the logical volume side and identifies a row indicating the original data to be overwritten. The subsequent process differs depending on whether the update data is duplicate data or new data.

When the update data is duplicate data, the input-output control unit 121 registers the data number of original data of which the update data is a duplicate as a data number in a column 306 indicating the data number of the identified row. Further, the input-output control unit 121 identifies a row representing the original data of which the update data is a duplicate in the management table 132 on the physical volume side. Then, the input-output control unit 121 increments a value in a reference counter column 308 in the identified row by one because a reference from the address of the current update data to the original data of which the update data is a duplicate is added. In this case, the update data is not newly stored in the stored data 210.

In this case, since an increase in the usage of the pool 200 due to the update data does not occur, the input-output control unit 121 keeps the value of the pool usage unchanged.

On the other hand, when the update data is new data, the input-output control unit 121 newly assigns a data number and registers information of the update data in the management table 131 on the logical volume side. Further, the input-output control unit 121 also registers information of the update data in the management table 132 on the physical volume side.

In this case, since the new data that is referenced data is additionally stored in the pool 200, the input-output control unit 121 adds usage by the new data to the pool usage.

Further, regardless of whether the update data is new data or duplicate data, the input-output control unit 121 executes the following process. The input-output control unit 121 identifies a row indicating original data to be overwritten. Then, the input-output control unit 121 decrements a value in a reference counter column 307 in the identified row by one because of one less reference from the address of the current update data to the original data to be overwritten. After that, the input-output control unit 121 determines whether or not the reference counter of the original data to be overwritten is zero.

If the reference counter is not zero, the data is referenced using some logical volume LBA, and thus the input-output control unit 121 determines that the original data to be overwritten is data in use. In this case, the input-output control unit 121 keeps the pool usage unchanged. On the other hand, if the reference counter of the original data to be overwritten is zero, the input-output control unit 121 determines that the original data to be overwritten is not referenced and is unnecessary data. In this case, since the original data to be overwritten becomes unnecessary data, the input-output control unit 121 subtracts usage by the original data to be overwritten from the pool usage.

Further, for example, when receiving a pool usage notification request from the host 2, the input-output control unit 121 transmits information of the pool usage it holds to the host 2 via the channel adapter 11. Consequently, an administrator can check the pool usage and can determine the amount of data in use after compression and deduplication at a certain point in time.

Returning to FIG. 2, the description will be continued. The garbage collection control unit 122 includes a timer for determining periodic execution of garbage collection. Then, the garbage collection control unit 122 detects the arrival of timing of the periodic execution of garbage collection using the timer, and starts the execution of garbage collection. Here, in the present embodiment, garbage collection is periodically executed, but it may be irregularly executed. For example, garbage collection may be executed based on the usage of the pool 200, or garbage collection may be executed according to an instruction from the administrator.

When executing garbage collection, the garbage collection control unit 122 determines a garbage collection setting and executes garbage collection based on the determined setting. In the present embodiment, the garbage collection control unit 122 uses priority indicating the proportion of a garbage collection process executed in entire processing executed in the storage system 1, as the garbage collection setting. In other words, the priority of a specific process according to the present embodiment is an index indicating that the higher the priority, the higher the proportion of the specific process executed in the entire processing executed in the storage system 1. The details of the garbage collection process by the garbage collection control unit 122 will be described below.

The garbage collection control unit 122 determines whether or not the system load of the storage system 1 is less than or equal to a threshold. If the system load is greater than the threshold, it is considered that the storage system 1 does not have processing capacity and enough resources for preferentially processing garbage collection. Therefore, the garbage collection control unit 122 sets the priority of the garbage collection process to normal.

On the other hand, if the system load is less than or equal to the threshold, the garbage collection control unit 122 acquires the pool usage from the input-output control unit 121. Further, the garbage collection control unit 122 acquires actual disk usage, which is usage by all the data stored in the pool 200, from the back-end control unit 105. The actual disk usage corresponds to an example of “second usage”.

Next, the garbage collection control unit 122 subtracts the pool usage from the actual disk usage. Then, the garbage collection control unit 122 determines whether or not the subtraction result representing the difference between the actual disk usage and the pool usage is greater than or equal to a threshold.

If the difference between the actual disk usage and the pool usage is less than the threshold, it is considered that there is little unnecessary data. If garbage collection is executed, unused space is not expected to increase so much. Therefore, the garbage collection control unit 122 sets the priority of garbage collection to normal.

On the other hand, if the difference between the actual disk usage and the pool usage is greater than or equal to the threshold, it is considered that there is a lot of unnecessary data. By executing garbage collection, unused space is expected to increase to some extent. Therefore, the garbage collection control unit 122 raises the priority of garbage collection. In the present embodiment, a case will be described in which there are two types of garbage collection priorities, a normal priority and a high priority.

After that, the garbage collection control unit 122 assigns garbage collection to CPU cores with the set priority, and causes the back-end control unit 105 to execute garbage collection. Here, priorities of processes according to the present embodiment will be described.

The priority setting according to the present embodiment is reflected in priorities of core allocation of the CPU 12 by a task scheduler and priorities of issuing commands to the disks by the back-end control unit 105 in the storage system 1.

The CPU 12 mounted on the storage system 1 includes a plurality of cores. Then, a control called a task scheduler assigns processes executed by the storage system 1 to each core for execution. During the assignment, the task scheduler fixes cores assigned a specific task, or causes a high-priority process to be executed before a low-priority process.

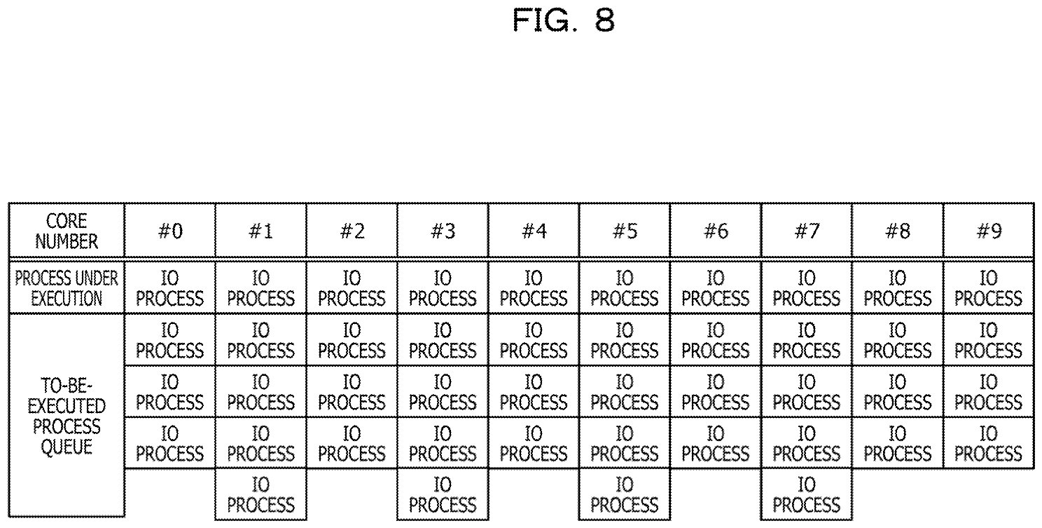

For example, a case will be described in which the CPU 12 includes cores #1 to #9, and the cores #1 to #9 execute an input/output (IO) process for processing read and write instructions from the host 2 and the garbage collection process. For example, when garbage collection is not executed, the cores #1 to #9 are assigned the IO process as depicted in FIG. 8. FIG. 8 is a diagram depicting process assignment when the garbage collection process is not assigned. A process corresponding to a process under execution in FIG. 8 is a process being executed by each of the cores #1 to #9. Then, processes corresponding to a to-be-executed process queue are processes that are already assigned to each of the cores #1 to #9 and will be sequentially processed from the top on the sheet when the process under execution is completed.

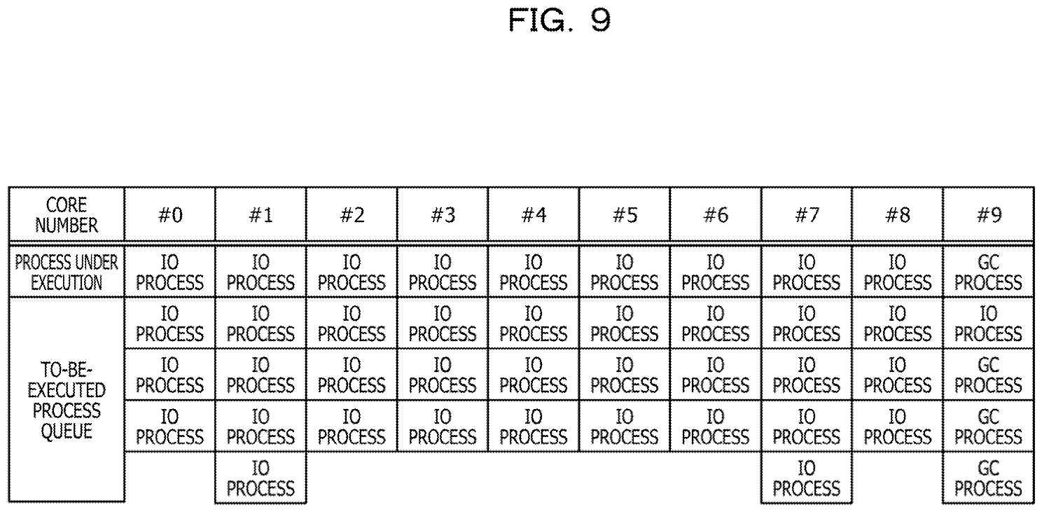

FIG. 9 is a diagram depicting process assignment when the priority of the garbage collection process is normal. What is described as a GC process in FIG. 9 corresponds to the garbage collection process. If the priority of garbage collection is normal, for example, the core #9 is assigned the garbage collection process, and the remaining cores #1 to #8 are assigned the IO process. In addition, if the normal priority is set for the garbage collection process, setting may be made such that the IO process is executed prior to the garbage collection process, and the garbage collection process is executed at IO process-free timings. Thus, when the normal priority is set for the garbage collection, the garbage collection process is executed without interfering with the IO process.

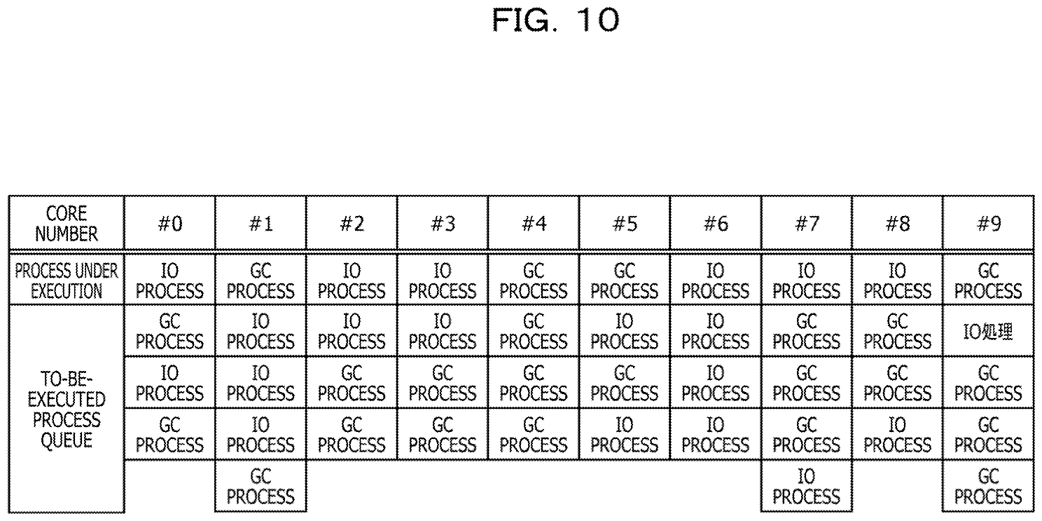

FIG. 10 is a diagram depicting process assignment when the priority of the garbage collection process is high. If the priority of the garbage collection process is high, the garbage collection process is assigned to the cores #1 to #9 equally with the IO process. In other words, on average, the IO process is executed on five cores, and the garbage collection process is executed on the remaining five cores. In this case, of the IO process and the garbage collection process, one registered fast is executed fast. This greatly increases the processing speed of the garbage collection process as compared with that at the normal time. On the contrary, the IO process is interfered with in execution to some extent. However, process assignment to the cores #1 to #9 is not fixed, and thus the garbage collection process may be operated on all the cores #1 to #9 in the absence of the IO process. On the contrary, in the absence of the garbage collection process, the IO process may be operated on all the cores #1 to #9.

Here, each core of the CPU 12 implements the functions of the input-output control unit 121, the cache memory control unit 104, the back-end control unit 105, and the disk interfaces 14, individually. In other words, it can be said that the garbage collection control unit 122 notifies the input-output control unit 121, the cache memory control unit 104, the back-end control unit 105, and the disk interfaces 14 that operate on each core of a priority set and causes them to execute processing. Thus, raising the priority in the present embodiment corresponds, specifically, to changing garbage collection execution setting to increase the proportion of the garbage collection process in the entire processing executed by the controller module 10.

Further, in addition to the task scheduling, in the storage system 1 according to the present embodiment, the priority is also reflected in the proportion at the time of data flow rate control on the disks 20 executed by the back-end control unit 105. When issuing commands to the plurality of disks 20 constituting a RAID group, the back-end control unit 105 determines how many extension commands for the garbage collection process should be issued according to the priority. If the priority of the garbage collection process is normal, the back-end control unit 105 preferentially issues IO process commands, and issues garbage collection process extension commands after issuing the IO process commands. On the other hand, if the priority of the garbage collection process is high, the back-end control unit 105 issues garbage collection process extension commands equally with IO process commands.

The garbage collection control unit 122 corresponds to an example of a “space freeing-up execution unit”. Further, garbage collection executed by the garbage collection control unit 122 corresponds to an example of a “space freeing-up process”. However, the space freeing-up process that is executed based on the difference between the pool usage and the actual disk usage may correspond to any other process that can increase free space on the disks 20.

In the above explanation, the case has been described in which there are two types of garbage collection priorities, the normal priority and the high priority, but there may be multiple levels of priority from the normal priority to the highest priority. When raising the priority of garbage collection, the garbage collection control unit 122 selects and sets a priority higher than the normal priority among the multiple levels of priority. The garbage collection control unit 122 may perform the priority selection according to the size of the actual disk space or the size of the difference between the actual disk space and the pool usage.

Returning to FIG. 2, the description will be continued. The cache memory control unit 104 receives input of an instruction to write data from the input-output control unit 121. Then, the cache memory control unit 104 writes the data to be written to a cache area of the DRAM 13, and outputs a write completion response to the input-output control unit 121. After that, the cache memory control unit 104 asynchronously reads the data to be written from the cache area of the DRAM 13, and outputs a write instruction to the back-end control unit 105.

Furthermore, the cache memory control unit 104 receives input of an instruction to read data from the input-output control unit 121. Then, the cache memory control unit 104 checks whether or not the data to be read exists in the cache area of the DRAM 13. If a cache hit occurs, the cache memory control unit 104 reads the data to be read from the cache area of the DRAM 13, and outputs the data to the input-output control unit 121.

On the other hand, if a cache miss hit occurs, the cache memory control unit 104 outputs a data read instruction to the back-end control unit 105. After that, the cache memory control unit 104 receives input of the data to be read from the back-end control unit 105. Then, the cache memory control unit 104 stores the acquired data to be read in the cache area of the DRAM 13, and deletes unnecessary data if the cache is full. Further, the cache memory control unit 104 outputs the data to be read to the input-output control unit 121.

The back-end control unit 105 generates the pool 200 and a logical volume based on the configuration information of the disks 20 transmitted from the host 2. At this time, the back-end control unit 105 initializes the actual disk usage, which is usage by all data in the pool 200, to zero.

The back-end control unit 105 receives an instruction to write data from the cache memory control unit 104. Then, the back-end control unit 105 issues a data write command to the disk 20 via the disk interface 14 to store the data.

Furthermore, the back-end control unit 105 receives an instruction to read data from the cache memory control unit 104. Then, the back-end control unit 105 issues a data read command to the disk 20 via the disk interface 14 to acquire the data. After that, the back-end control unit 105 outputs the read data to the cache memory control unit 104.

Furthermore, the back-end control unit 105 receives an instruction to execute garbage collection from the garbage collection control unit 122. Then, the back-end control unit 105 refers to the metadata table 103 and identifies unnecessary data that is data not referenced. Then, the back-end control unit 105 deletes the unnecessary data. At this time, the back-end control unit 105 issues garbage collection process extension commands according to the priority of garbage collection specified in the garbage collection execution instruction.

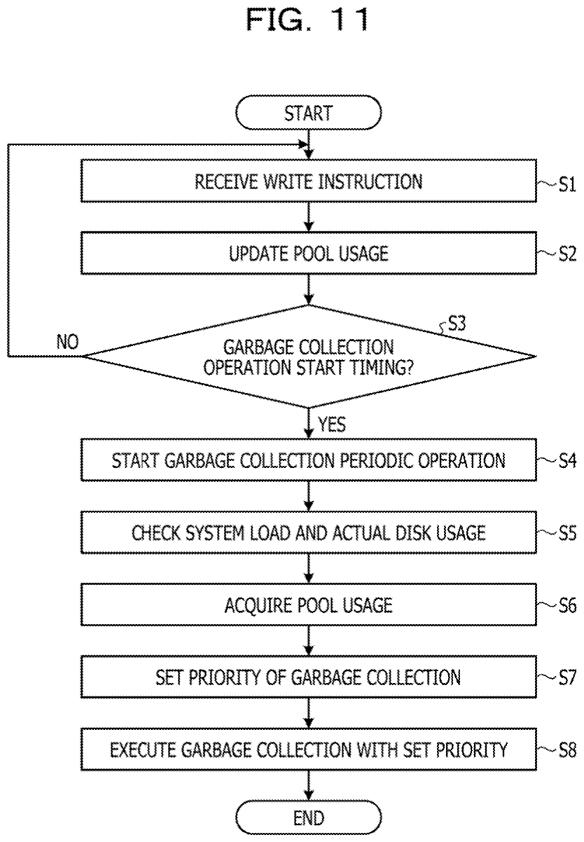

Next, with reference to FIG. 11, the overall flow of the garbage collection process by the controller module 10 according to the present embodiment will be described. FIG. 11 is an overall flowchart of the garbage collection process.

The input-output control unit 121 receives a write instruction transmitted from the host 2 via the channel adapter 11 (step S1).

Next, the input-output control unit 121 updates the pool usage it holds (step S2).

The garbage collection control unit 122 determines whether or not the garbage collection operation timing has arrived, using the timer (step S3). If the garbage collection operation timing has not arrived (step S3: No), processing of the duplication-compression control unit 102 returns to step S1.

On the other hand, if the garbage collection operation timing has arrived (step S3: Yes), the garbage collection control unit 122 starts the periodic operation of garbage collection (step S4).

Next, the garbage collection control unit 122 checks the system load of the storage system 1. In addition, the garbage collection control unit 122 acquires the actual disk usage from the back-end control unit 105 and checks it (step S5).

Next, the garbage collection control unit 122 acquires the pool usage from the input-output control unit 121 (step S6).

Next, the garbage collection control unit 122 sets the priority of garbage collection using the pool usage and the actual disk usage (step S7).

After that, the garbage collection control unit 122 instructs the input-output control unit 121, the cache memory control unit 104, and the back-end control unit 105 to execute garbage collection with the set priority. The input-output control unit 121, the cache memory control unit 104, and the back-end control unit 105 execute garbage collection with the set priority while executing the IO process (step S8).

Here, the controller module 10 executes the IO process in parallel even while executing the garbage collection process in steps S4 to S8 of FIG. 11.

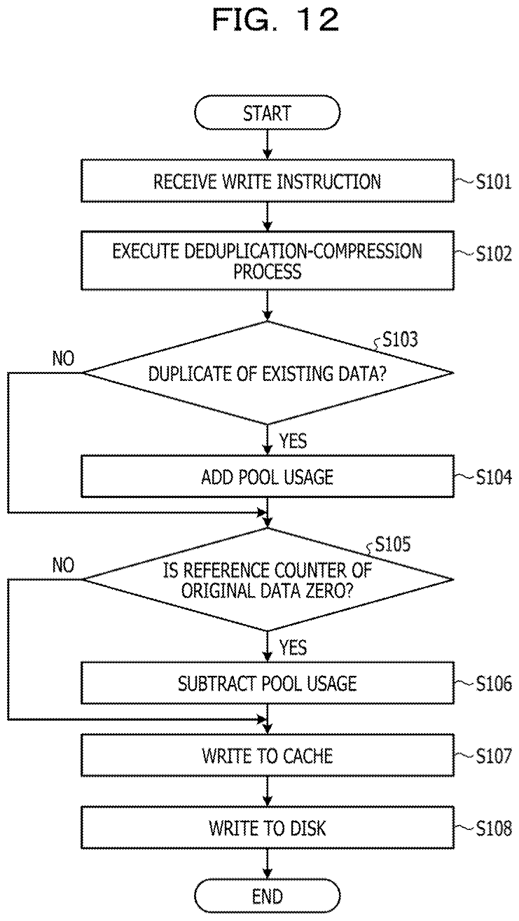

Next, with reference to FIG. 12, the flow of a pool usage calculation process will be described. FIG. 12 is a flowchart of the pool usage calculation process. The process depicted in FIG. 12 corresponds to an example of the process executed in steps S1 and S2 in FIG. 11.

The input-output control unit 121 receives a write instruction transmitted from the host 2 via the channel adapter 101 (step S101).

Next, the input-output control unit 121 executes a deduplication-compression process to execute write of specified data (step S102).

Next, the input-output control unit 121 determines whether or not the data to be written is a duplicate of existing data (step S103). If the data to be written is a duplicate of existing data (step S103: Yes), the input-output control unit 121 proceeds to step S105.

On the other hand, if the data to be written is not a duplicate of existing data (step S103: No), the input-output control unit 121 adds usage by the data to be written to the pool usage (step S104).

After that, the input-output control unit 121 determines whether or not the reference counter of original data when the write is overwriting is zero (step S105). If the reference counter of the original data is not zero (step S105: No), the input-output control unit 121 proceeds to step 107.

On the other hand, if the reference counter of the original data is zero (step S105: Yes), the input-output control unit 121 subtracts usage by the original data from the pool usage (step S106).

After that, the input-output control unit 121 outputs the data to be written to the cache memory control unit 104 if there is not duplicate existing data. Then, the cache memory control unit 104 writes the data to the cache (step S107).

After that, the cache memory control unit 104 reads the data to be written asynchronously from the cache and outputs the data to the back-end control unit 105. The back-end control unit 105 issues a write command to write the data input from the cache memory control unit 104 to the disk 20 via the disk interface 14 to write the data to the disk 20 (step S108).

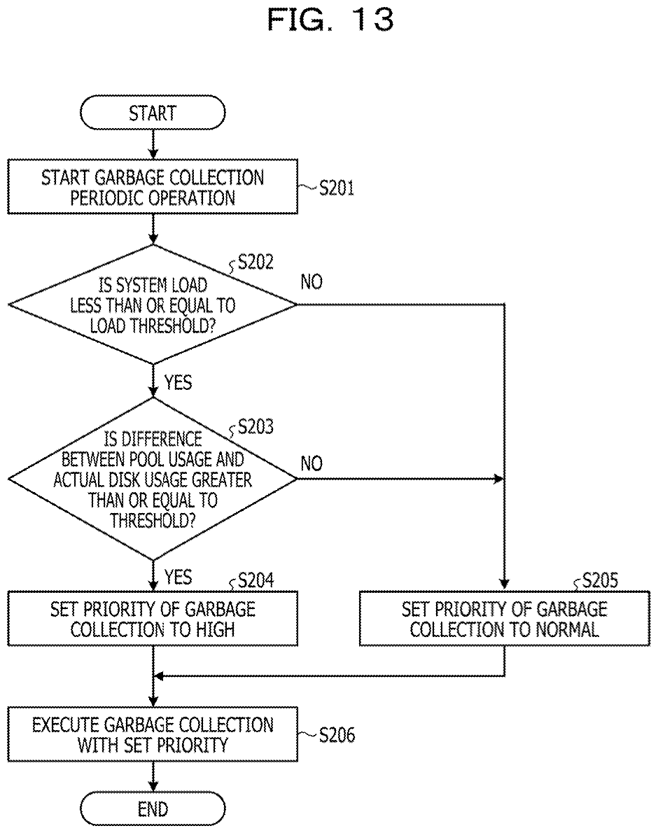

Next, with reference to FIG. 13, the flow of a priority setting process by the controller module 10 according to the first embodiment will be described. FIG. 13 is a flowchart of the priority setting process according to the first embodiment. The process depicted in FIG. 13 corresponds to an example of the process executed in steps S4 to S8 in FIG. 11.

The garbage collection control unit 122 starts the periodic operation of garbage collection (step S201).

Next, the garbage collection control unit 122 acquires the system load of the storage system 1, and determines whether or not the system load is less than or equal to a load threshold (step S202). If the system load is less than or equal to the load threshold (step S202: Yes), the garbage collection control unit 122 subtracts the pool usage from the actual disk usage, and determines whether or not the difference between the pool usage and the actual disk usage is greater than or equal to a threshold (step S203).

If the difference between the pool usage and the actual disk usage is greater than or equal to the threshold (step S203: Yes), the garbage collection control unit 122 sets the priority of garbage collection to high (step S204).

On the other hand, if the system load is greater than the load threshold (step S202: No), the garbage collection control unit 122 sets the priority of garbage collection to normal (step S205). Likewise, if the difference between the pool usage and the actual disk usage is less than the threshold (step S203: No), the garbage collection control unit 122 sets the priority of garbage collection to normal (step S205).

After that, the garbage collection control unit 122 instructs the input-output control unit 121, the cache memory control unit 104, and the back-end control unit 105 to execute garbage collection with the set priority. The input-output control unit 121, the cache memory control unit 104, and the back-end control unit 105 execute garbage collection with the set priority while executing the IO process (step S206).

As described above, the controller module according to the present embodiment calculates the difference between the pool usage, which is usage by data in use, and the actual disk usage, which is usage by all data. Then, if the difference between the actual disk usage and the pool usage is greater than or equal to the threshold, the controller module raises the priority of garbage collection execution. In other words, the controller module changes the garbage collection execution setting to increase the proportion of garbage collection in the entire processing executed by the controller module.

Consequently, when the execution of garbage collection is effective in freeing up disk space, the proportion of garbage collection can be increased to free up space quickly. In other words, if the execution of garbage collection does not provide sufficient effect, by maintaining the proportion of the garbage collection process, more CPU performance can be used for the IO process from the host computer. As a result, limited disk resources can be used efficiently, allowing the storage system to effectively exhibit system performance.

In addition, by changing the garbage collection setting using the system load, for example, garbage collection can be operated preferentially to free up disk space at timings when the system load is low and there is enough capacity, and influence on the IO process can be limited.

As described above, the controller module according to the present embodiment can appropriately maintain a balance between freeing up space and processing load in the storage device, and can improve the device performance of the storage device.

### Second Embodiment

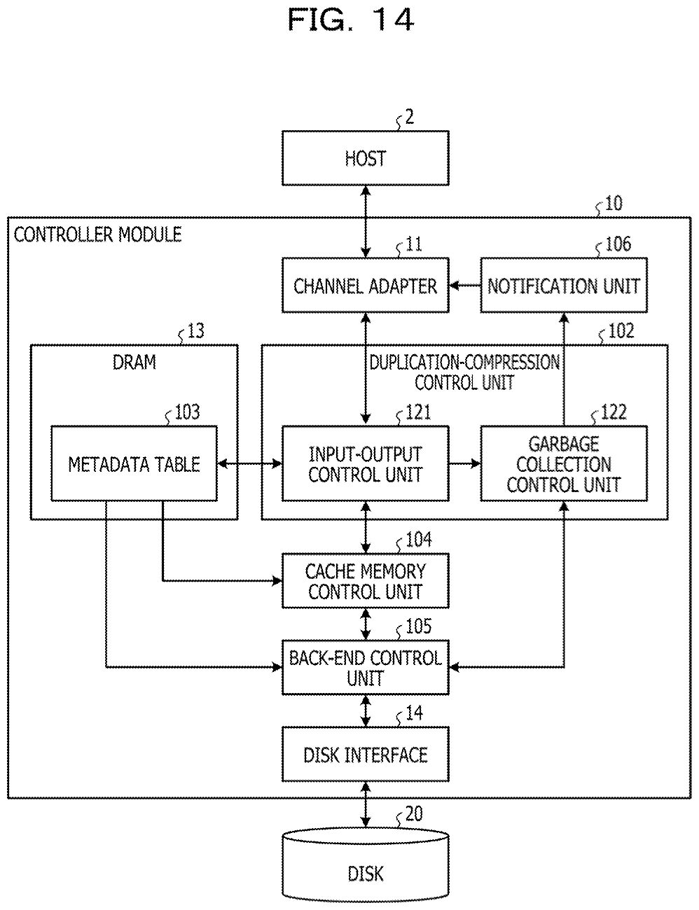

FIG. 14 is a block diagram of a controller module according to a second embodiment. A controller module 10 according to the present embodiment is different from that in the first embodiment in that when the actual disk usage is greater than or equal to a threshold, it sets the priority of garbage collection to high and then makes a notification to an administrator. The controller module 10 according to the present embodiment includes a notification unit 106 in addition to each unit of the first embodiment. In the following description, the operation of each unit described in the first embodiment will not be described.

Upon starting the periodic operation of garbage collection, the garbage collection control unit 122 acquires the actual disk usage from the back-end control unit 105. Then, the garbage collection control unit 122 determines whether or not the actual disk usage is greater than or equal to a predetermined usage threshold.

If the actual disk usage is greater than or equal to the usage threshold, it can be determined that the free space of the disks 20 is small and it is risky. Therefore, the garbage collection control unit 122 sets the priority of garbage collection to high. Next, the garbage collection control unit 122 acquires the pool usage from the input-output control unit 121. Then, the garbage collection control unit 122 subtracts the pool usage from the actual disk usage, and determines whether or not the difference between the pool usage and the actual disk usage, which is the subtraction result, is greater than or equal to the threshold. Then, the garbage collection control unit 122 notifies the notification unit 106 of the determination result.

On the other hand, if the actual disk usage is less than the usage threshold, there is enough free space on the disks 20, so that the garbage collection control unit 122 determines the priority of garbage collection using the system load and the difference between the pool usage and the actual disk usage as in the first embodiment.

The notification unit 106 receives from the garbage collection control unit 122 a notification of the result of the determination of whether or not the difference between the pool usage and the actual disk usage is greater than or equal to the threshold.

If the difference between the pool usage and the actual disk usage is greater than or equal to the threshold, it can be expected that the execution of garbage collection can free up some disk space. Therefore, the notification unit 106 notifies the administrator of a decrease in the performance of the storage system 1.

On the other hand, if the difference between the pool usage and the actual disk usage is less than the threshold, it can be expected to be difficult to free up disk space even if garbage collection is executed. Therefore, the notification unit 106 notifies the administrator of a recommendation to add disks 20. The function of the notification unit 106 is also implemented by the CPU 12.

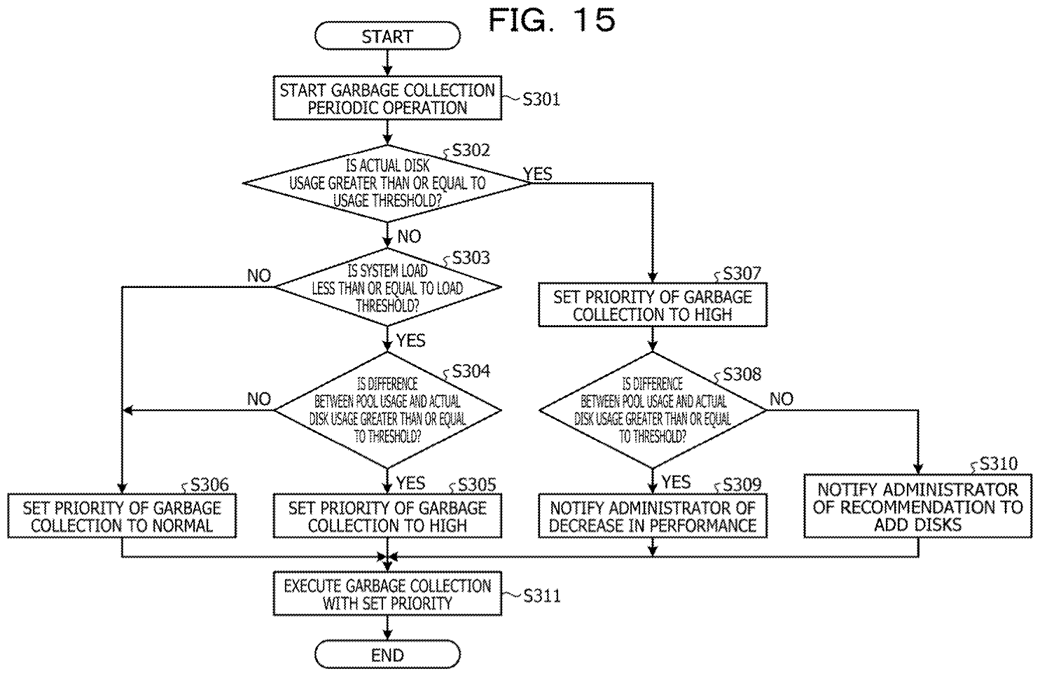

Next, with reference to FIG. 15, the flow of a priority setting process by the controller module 10 according to the present embodiment will be described. FIG. 15 is a flowchart of the priority setting process according to the second embodiment.

The garbage collection control unit 122 starts the periodic operation of garbage collection (step S301).

Next, the garbage collection control unit 122 acquires the actual disk usage from the back-end control unit 105. Then, the garbage collection control unit 122 determines whether or not the actual disk usage is greater than or equal to the usage threshold (step S302).

If the actual disk usage is less than the usage threshold (step S302: No), the garbage collection control unit 122 acquires the system load of the storage system 1, and determines whether or not the system load is less than or equal to the load threshold (step S303). If the system load is less than or equal to the load threshold (step S303: Yes), the garbage collection control unit 122 subtracts the pool usage from the actual disk usage, and determines whether or not the difference between the pool usage and the actual disk usage is greater than or equal to the threshold (step S304).

If the difference between the pool usage and the actual disk usage is greater than or equal to the threshold (step S304: Yes), the garbage collection control unit 122 sets the priority of garbage collection to high (step S305).

On the other hand, if the system load is greater than the load threshold (step S303: No), the garbage collection control unit 122 sets the priority of garbage collection to normal (step S306). Likewise, if the difference between the pool usage and the actual disk usage is less than the threshold (step S304: No), the garbage collection control unit 122 sets the priority of garbage collection to normal (step S306).

On the other hand, if the actual disk usage is greater than or equal to the usage threshold (step S302: Yes), the garbage collection control unit 122 sets the priority of garbage collection to high (step S307).

Next, the garbage collection control unit 122 acquires the pool usage from the input-output control unit 121. Then, the garbage collection control unit 122 subtracts the pool usage from the actual disk usage, and determines whether or not the difference between the pool usage and the actual disk usage is greater than or equal to the threshold (step S308). Then, the garbage collection control unit 122 notifies the notification unit 106 of the determination result.

If the difference between the pool usage and the actual disk usage is greater than or equal to the threshold (step S308: Yes), the notification unit 106 notifies the administrator of a decrease in the performance of the storage system 1 (step S309).

On the other hand, if the difference between the pool usage and the actual disk usage is less than the threshold (step S308: No), the notification unit 106 notifies the administrator of a recommendation to add disks 20 (step S310).

After that, the garbage collection control unit 122 instructs the input-output control unit 121, the cache memory control unit 104, and the back-end control unit 105 to execute garbage collection with the set priority. The input-output control unit 121, the cache memory control unit 104, and the back-end control unit 105 execute garbage collection with the set priority while executing the IO process (step S311).

As described above, the controller module according to the present embodiment sets the priority of garbage collection to high if the actual disk usage is greater than or equal to the usage threshold. Further, the controller module notifies the administrator of the current state of the storage system determined from the difference between the pool usage and the actual disk usage.

Consequently, if free disk space is small, the garbage collection process can be prioritized to quickly free up disk space. In addition, if free disk space is small and considered to be in a risky state, the administrator can be notified of the state of the storage system to be urged to address it before a problem occurs, so that the continuity of operation of the storage system can be maintained to ensure reliability.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory; and
a processor coupled to the memory and configured to:
receive an instruction to write data, executes processing to write the data to storage space of a storage device, and acquires first usage by in-use data in the storage space according to content of the write processing when the write processing has been executed; and
determine setting of a space freeing-up process, based on the first usage acquired by the write processing unit and second usage by all data stored in the storage space, and executes the space freeing-up process with the determined setting.

2. The information processing device according to claim 1, wherein the processor determines the setting of the space freeing-up process, based on processing load of the storage device in addition to the first usage and the second usage.

3. The information processing device according to claim 1, wherein the processor determines the setting, based on a difference between the first usage and the second usage.

4. The information processing I device according to claim 1, wherein the setting is a proportion of the space freeing-up process in processing executed by the storage device.

5. The information processing device according to claim 4, wherein the processor increases the proportion of the space freeing-up process when the difference between the first usage and the second usage is greater than or equal to a threshold.

6. The information processing device according to claim 1, wherein the processor executes a deduplication process and a compression process in the write processing, writes the data and stores reference information for the written data when the data is not a duplicate of existing data, or stores the reference information for the existing data when the data is a duplicate of the existing data, or deletes the reference information for the existing data when the existing data is overwritten, and sets data having the reference information as the in-use data based on the reference information.

7. The information processing device according to claim 1, wherein the processor executes deletion of unnecessary data other than the in-use data in the storage space as the space freeing-up process.

8. The information processing device according to claim 4, wherein the processor increases the proportion of the space freeing-up process when the second usage is greater than or equal to a threshold.

9. The information processing device according to claim 1, wherein the processor determines and makes a notification of a state of the storage device based on the difference between the first usage and the second usage when the second usage is greater than or equal to a usage threshold.

10. A non-transitory computer-readable recording medium having stored therein a storage control program for causing a computer to execute a process comprising:
receiving an instruction to write data and executing processing to write the data to storage space of a storage device;
acquiring first usage by usable data except unnecessary data in the storage space according to content of the write processing when the write processing has been executed;
determining setting of a space freeing-up process, based on the acquired first usage and second usage by all data stored in the storage space; and
executing the space freeing-up process with the determined setting.
